(19) United States
(12) Patent Application Publication
(10) Pub. No.: US 2010/0146267 A1
(43) Pub. Date: Jun. 10, 2010

(54) Systems and methods for providing secure platform services

(76) Inventors: David Konetski, Austin, TX (US); Richard W. Schuckle, Austin, TX (US); Frank H. Molsberry, Georgetown, TX (US)

Correspondence Address: O'KEEFE, EGAN, PETERMAN & ENDERS LLP, 1101 CAPITAL OF TEXAS HIGHWAY SOUTH, #C200, AUSTIN, TX, 78746, US

(21) Appl. No.: 12/316,189

(22) Filed: Dec. 10, 2008

(51) Int. Cl. H04L 9/00

(52) U.S. Cl. 713/164; 713/150

(57) ABSTRACT

Systems and methods for providing secure platform services using an information handling system, and which may be implemented to sequester or otherwise isolate sensitive cryptographic processes, as well as the keys used during such decryption and encryption processes. The systems and methods may be implemented as a set of secure services that are available to an operating system or to a Hypervisor executing on an information handling system, and the processing environment may be provided as a closed environment, thus preventing malicious code from infiltrating the processing environment. Dedicated and secure memory space may be employed to prevent key detection through memory scans.

### FIELD OF THE INVENTION

This invention relates generally to information handling systems, and more particularly to providing secure platform services for information handling systems.

### BACKGROUND OF THE INVENTION

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Current software encryption and decryption systems are vulnerable to software attacks. Encryption services have been provided as an operating system service that employs general operating system resources and open memory and processing to retrieve keys. Encryption services have also been provided as a proprietary application with proprietary codes that also employ open memory. Trying to secure keys at the operating system kernel level is inherently insecure, since drivers and applications can be allowed to reach the same level of hardware privilege by an administrator, or by a user granted administrator privilege. By monitoring software and/or hardware interfaces, encryption keys may be discovered and exploited by unauthorized persons. For example, hackers can make use of code profiling routines to determine time spent in algorithms, and may identify code sequences that contain encryption and decryption routines. Once the routines have been identified, a hacker can extract the keys from the routines through various methods of debug and system monitoring.

### SUMMARY OF THE INVENTION

Disclosed herein are systems and methods for providing secure platform services for information handling systems. The disclosed systems and methods may be implemented to sequester or otherwise isolate sensitive encryption, decryption, hashing, authentication and/or other cryptographic processes, as well as the keys used during such decryption and encryption processes. In one embodiment, the disclosed systems and methods may be implemented as a set of secure services that are available to an operating system or to a Hypervisor executing on an information handling system. Advantageously, the processing environment of the disclosed systems and methods may be provided as a closed environment, thus preventing malicious code from infiltrating the processing environment. The disclosed methods and system may further employ dedicated and secure memory space to prevent key detection through memory scans. Code running in the closed and secure environment of the disclosed methods and system may be self checking, e.g., running integrity checks at short intervals during execution to ensure that the code has not been tampered with. Additionally, the code may further be required to pass an initial integrity check before loading.

In the practice of the disclosed systems and methods, secure cryptographic services may be implemented in hardware, firmware, and/or software such that the primary user of the services has no hardware privilege to divert any secure information from those services. In this regard, the disclosed secure cryptographic services may be further implemented to provide an interface to an information handling system that may be exposed as a single platform service for a single operating system (OS), or virtually through a virtual machine monitor (VMM) or Hypervisor to multiple guest operating systems. A security driver may be provided within the operating system that may communicate directly with a platform services application programming interface and appear as native support in the operating system.

In one respect, disclosed herein is an information handling system, including: a first processing device, at least one operating system executing on the first processing device; a second processing device configured to perform secure platform services that include at least one cryptographic task or at least one cryptographic key management task, the second processing device being inaccessible to the operating system; and dedicated memory coupled to the second processing device, the dedicated memory being inaccessible to the operating system. The first processing device may be configured to be coupled to the second processing device by a secure communication path that includes at least one of a secure authenticated channel, an encrypted channel, or a secure session.

In another respect, disclosed herein is a method of providing secure services for an information handling system, including: providing an information handling system including first and second processing devices, and dedicated memory coupled to the second processing device; providing at least one operating system executing on the first processing device; and performing secure platform services that include at least one decryption or encryption task or at least one cryptographic key management task using the second processing device. In one embodiment, the second processing device and the dedicated memory are inaccessible to the operating system, and the first processing device may be coupled to the second processing device by a secure communication path that includes at least one of a secure authenticated channel, an encrypted channel, or a secure session.

In another respect, disclosed herein is an information handling system, including: a first processing device, at least one operating system and a virtual machine environment executing on the first processing device, the virtual machine environment being inaccessible to the operating system; and dedicated memory coupled to the first processing device, the dedicated memory being accessible to the virtual machine environment and being inaccessible to the operating system. The virtual machine environment may be configured to perform secure platform services that include at least one decryption or encryption task or at least one cryptographic key management task, and the virtual machine environment may be configured to communicate with the operating system by a secure communication path that includes a virtualization layer and that includes at least one of a secure authenticated channel, an encrypted channel, or a secure session.

In another respect, disclosed herein is a method of providing secure services for an information handling system, including: providing an information handling system including a first processing device; providing at least one operating system and a virtual machine environment executing on the first processing device, the virtual machine environment being inaccessible to the operating system; providing dedicated memory coupled to the first processing device, the dedicated memory being accessible to the virtual machine environment and being inaccessible to the operating system; and performing secure platform services using the virtual machine environment, the secure platform services including at least one decryption or encryption task or at least one cryptographic key management task. The virtual machine environment may be configured to communicate with the operating system by a secure communication path that includes a virtualization layer and that includes at least one of a secure authenticated channel, an encrypted channel, or a secure session.

### BRIEF DESCRIPTION OF THE DRAWINGS

FIG. 1 is a simplified block diagram of a network of information handling systems according to one exemplary embodiment of the disclosed systems and methods.

FIG. 2 is a simplified block diagram of an information handling system as it may be configured according to one exemplary embodiment of the disclosed systems and methods.

FIG. 3 is a simplified block diagram showing secure platform services implemented according one exemplary embodiment of the disclosed systems and methods.

FIG. 4 is a simplified block diagram showing secure platform services implemented according one exemplary embodiment of the disclosed systems and methods.

FIG. 5 is a simplified block diagram showing secure platform services implemented according one exemplary embodiment of the disclosed systems and methods.

### DESCRIPTION OF ILLUSTRATIVE EMBODIMENTS

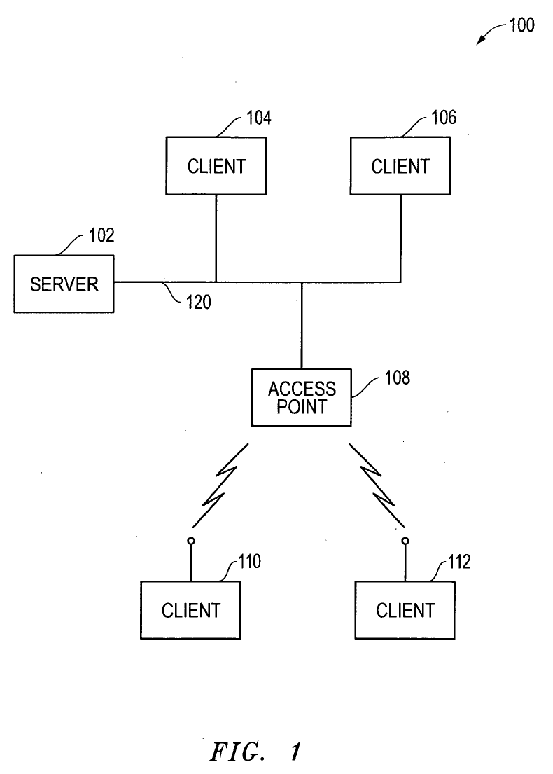

FIG. 1 illustrates a network 100 of information handling systems 102, 104, 106, 108, 110 and 112 that are coupled together via network 120 (e.g., Internet, wide area network, local area network, etc.), and with each of which the disclosed systems and methods may be implemented in one exemplary embodiment. In the illustrated embodiment, information handling system 102 is configured as a network server and each of information handling systems 104, 106, 110 and 112 are configured as client devices that access server 102 across network 120. As shown in FIG. 1, each of client devices 110 and 112 communicate wirelessly with network 120 via information handling system 108 which in this embodiment is configured as a wireless access point. Each of client devices 104, 106, 110 and 112 may be, for example, a desktop personal computer, a notebook computer, personal data assistant, thin client, etc.

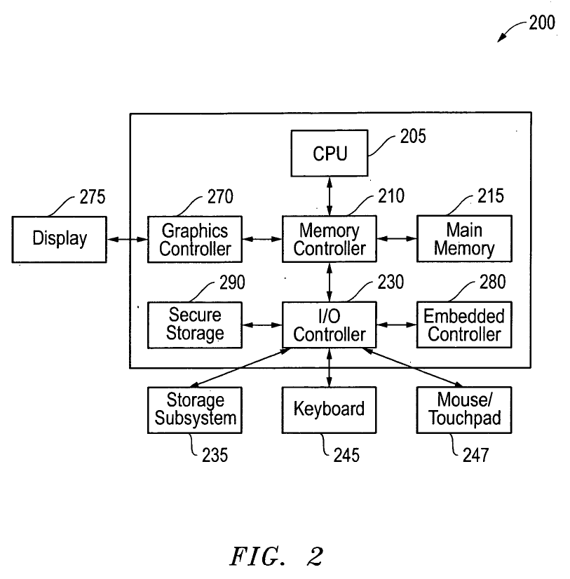

FIG. 2 is a block diagram of an information handling system 200 as it may be configured, for example, as any one of information handling systems 102, 104, 106, 108, 110 and 112 of FIG. 1. As shown in FIG. 2, information handling system 200 of this exemplary embodiment includes a CPU 205 such as an Intel Pentium series processor, an Advanced Micro Devices (AMD) processor or one of many other processors currently available. A memory controller 210 is coupled to processor 205 to facilitate memory functions. System memory 215 and a graphics controller 270 may be coupled to memory controller 210. A display 275 (e.g, LCD display or other suitable display device) is coupled to graphics controller 270 to provide visual images to the user. An I/O controller 230 is coupled to memory controller 210 to facilitate input/output functions for the information handling system. Local system storage 235 (e.g., one or media drives such as hard disk drive/s, optical drives, etc.) may be coupled to I/O controller 230 to provide permanent system storage for the information handling system. Input devices such as a keyboard 245 and touchpad 247 may be coupled to I/O controller 230 to enable the user to interact with the information handling system. An embedded controller (EC) 280 running system firmware and a secure storage 290 are each also coupled to I/O controller 230. Secure storage 290 is a hardware device that provides storage of cryptographic keys for information handling system 200. It will be understood that the particular configuration of FIG. 2 is exemplary only, and that an information handling system may be configured with fewer, additional or alternative components than those illustrated in FIG. 2.

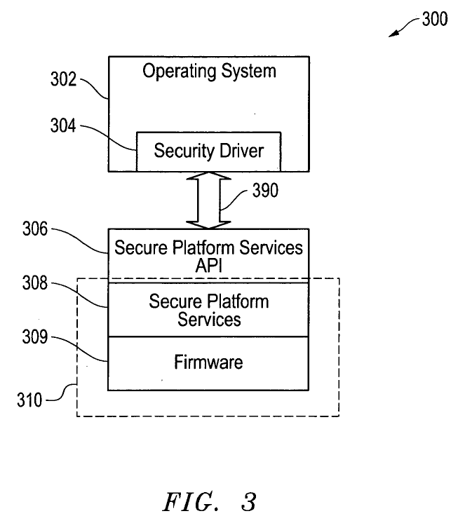

FIG. 3 shows one exemplary embodiment of secure platform services 310 as it may be implemented as a dedicated and secure hardware processing unit 308 with embedded firmware 309 on an information handling system, such as information handling system 200 of FIG. 2. In the illustrated embodiment, secure platform services 310 are implemented as a protected memory environment (e.g., using Intel Trusted Execution Technology (TXT), AMD-V, etc.), that functions to physically isolate and partition memory. It will be understood that functions of secure hardware processing unit 308 and embedded firmware 309 may be alternatively implemented, for example, with a dedicated processor core having dedicated secure memory. Other types of secure memory include, but are not limited to, sequestered random access memory (RAM). Also shown in FIG. 3 is a secure platform services application programming interface (API) 306 which provides an interface between secure platform services 310 and a secure services client provided in the form of operating system 302 via a security driver 304, which also may be implemented on information handling system 200. In this exemplary embodiment, security driver 304 is configured to perform the function of providing standardized communication protocol to OS 302, while secure platform services API 306 provides communication between security driver 304 and secure platform services 310. In this embodiment, operating system 302 may be executing on a first processing device, (e.g., a central processing unit (CPU) of a desktop or notebook computer), and secure hardware processing unit 308 may be implemented by, for example, a second processing device such as cryptographic processor. Secure communication path 390 between security driver 304 and secure hardware processing unit 308 may be provided by at least one of a secure authenticated channel, an encrypted, or a secure session.

Secure cryptographic processes take place within dedicated hardware processing unit 308, using dedicated secure firmware 309. In this regard, hardware processing unit 308 may be implemented as a dedicated cryptographic processor or as a dedicated CPU core that operates to perform secure cryptographic processes that may include, but are not limited to, authentication, hashing, encryption, or decryption. Firmware 309 may be implemented as embedded software that is configured to provide routines and algorithms for execution on hardware processing unit 308. In this embodiment, secure platform services 310 are provided and configured to manage keys and cryptographic activities in a manner that prevents critical keys from being exposed at the operating system kernel level or at the driver level, and in one exemplary embodiment open keys are completely contained within the boundary of secure platform services 310. Since secure platform services 310 are provided outside operating system 302, operating system 302 does not have access to either the memory or compute environment that is used to encrypt the keys, thus the ability for key management keys and/or encryption/decryption activities to be monitored and exposed to software attacks is greatly reduced.

Still referring to the exemplary embodiment of FIG. 3, secure platform services API interface 306 provides a bi-directional authentication process to ensure that the secure platform services 310 and the secure services client (i.e., operating system 302) consider each other trustworthy. The authentication process may include the establishment of a secure authenticated channel, the establishment of an encrypted channel, or the establishment of a secure session between the secure platform services 308 and security driver 304 of the secure services client which is operating system 302 in this embodiment. In this regard, bidirectional authentication steps performed by secure platform services API interface 306 may include, for example, the steps of shared secret, challenge response, public key infrastructure, or any other bi-directional authentication protocol. After bi-directional authentication is successfully performed, secure communication is then allowed to take place between secure platform services 310 and the secure services client (i.e., operating system 302).

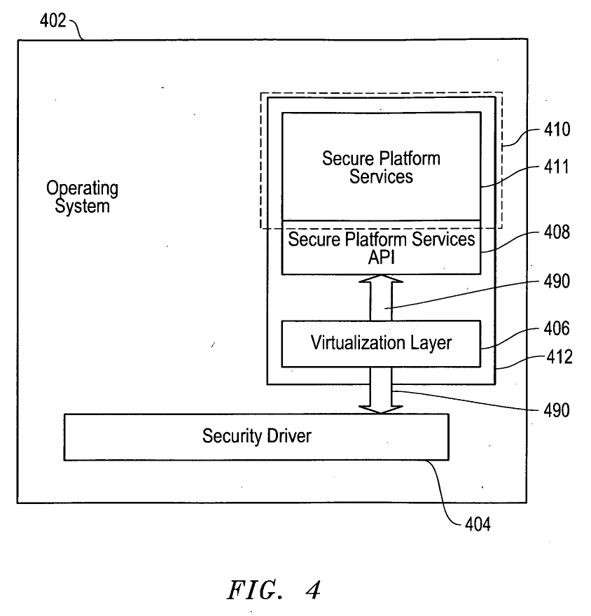

FIG. 4 shows an alternate embodiment of secure platform services 410 as it may be implemented (e.g., as software 411) within a secure virtual machine environment 412 that is hosted within an operating system 402 running on an information handling system, such as information handling system 200 of FIG. 2, so that secure virtual machine environment 412 is protected from the remainder of operating system 402. As shown, secure virtual machine environment 412 also includes a virtualization layer 406 that may be implemented, for example, by a combination of hardware features (e.g., Intel Virtualization Technology (VT) implemented by Intel processor, AMD-V virtualization, etc.) and/or software features (e.g., VMware “Workstation”, Microsoft “Virtual PC”, etc.) that together function to provide isolated memory and processing resources. Also shown as part of secure virtual machine environment 412 in FIG. 4 is a secure platform services application programming interface (API) 408 which provides an interface between secure platform services 410 and virtualization layer 406 of secure virtual machine environment 412. Virtualization layer 406 in turn interfaces with the secure services client of this embodiment (i.e., operating system 402) via security driver 404, which performs a function as described previously for security driver 304 of FIG. 3. As shown, secure communication paths 490 (e.g., at least one of a secure authenticated channel, an encrypted channel, or a secure session) may be provided between security driver 404 and secure virtualization layer 406, and between virtualization layer 406 and secure platform services API 408.

In this exemplary embodiment, the calling portion of operating system 402 does not have access to code running within secure virtual machine environment 412, nor does it have access to memory dedicated to the secure virtual machine environment 412. Further, secure encryption/decryption processes are bound within the virtual machine environment 412 and external processes are not given access to virtual machine environment processes or memory. Further, secure platform services 410 are provided and configured to manage keys and encryption/decryption activities in a manner that prevents critical keys from being exposed at the operating system kernel level or at the driver level, and in one exemplary embodiment open keys are completely contained within the boundary of secure platform services 410. Thus, operating system 402 does not have access to either the memory or compute environment that is used to contain the keys, and the ability for key management and/or cryptographic activities to be monitored and exposed to software attacks is greatly reduced.

As with the embodiment of FIG. 3, secure platform services API interface 408 of FIG. 4 provides a bi-directional authentication process to ensure that the secure platform services 410 and the secure services client (i.e., operating system 402) consider each other trustworthy. The authentication process may include the establishment of a secure authenticated channel, the establishment of an encrypted channel, or the establishment of a secure session between the secure platform services 410 and security driver 404 of operating system 402. In this regard, bidirectional authentication steps performed by secure platform services API interface 408 may include the same bidirectional authentication steps previously described for secure platform services API interface 306, and security driver 404 may be present to perform the task/s as previously described for security driver 304 of FIG. 3. After bidirectional authentication is successfully performed, secure communication is then allowed to take place between secure platform services 410 and the secure services client (i.e., operating system 402).

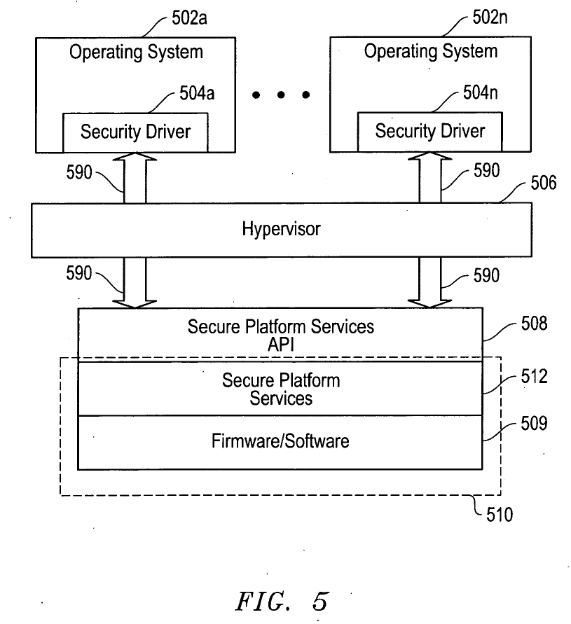

FIG. 5 shows an alternate embodiment of secure platform services 510 as it may be implemented as a secure environment under a hypervisor or virtual machine monitor 506 implemented, for example, by a combination of hardware features (e.g., Intel Virtualization Technology (VT), AMD-V virtualization, etc.) and software features (e.g., Xen, VMware “ESX”, Microsoft “Hyper-V”, etc.) that function to provide isolated memory and processing resources. As shown, secure platform services 510 of this embodiment may be implemented as a dedicated and secure hardware processing unit 512 with embedded firmware or software 509 on an information handling system, such as information handling system 200 of FIG. 2. In the illustrated embodiment of FIG. 5, secure platform services 510 may be implemented as a protected memory environment as described previously for FIG. 3. It will be understood that functions of secure hardware processing unit 512 and embedded firmware 509 may be alternatively implemented, for example, with a dedicated processor core having dedicated secure memory. Also shown in FIG. 5 is a secure platform services application programming interface (API) 508 which provides an interface between secure platform services 510 and hypervisor 506, which in turn communicates with each of secure services clients provided in the form of multiple guest operating systems 502a through 502n via a respective security driver 504a through 504n for each of multiple guest operating systems 502a through 502n. As shown, secure communication paths 590 (e.g., at least one of a secure authenticated channel, an encrypted channel, or a secure session) may be provided between security drivers 504 and hypervisor 506, and between hypervisor 506 and secure platform services API 508. Each of multiple guest operating systems 502a through 502n may be implemented on information handling system 200.

In the exemplary embodiment of FIG. 5, secure cryptographic processes are bound within the secure environment 512 (secure hardware processing unit 512) and use dedicated secure memory provided by hypervisor 506. Hypervisor 506, in this case, is aware of the secure nature of the secure environment 512, and prevents access by other guest environments to any of the secure environment's resources. Further, secure platform services 510 are provided and configured to manage keys and cryptographic activities in a manner that prevents critical keys from being exposed at the operating system kernel level or at the driver level, and in one exemplary embodiment open keys are completely contained within the boundary of secure platform services 510. Since secure platform services 510 are provided outside multiple operating systems 502a through 502n, operating systems 502a through 502n do not have access to either the memory or compute environment that is used to encrypt the keys, thus the ability for key management keys and/or cryptographic activities to be monitored and exposed to software attacks is greatly reduced.

As with the embodiment of FIG. 3, secure platform services API interface 508 of FIG. 5 provides a bidirectional authentication process to ensure that the secure platform services 510 and the given secure services client at a particular time (i.e., one of multiple guest operating systems 502a through 502n) consider each other trustworthy. The authentication process may include the establishment of a secure authenticated channel, the establishment of an encrypted channel, or the establishment of a secure session between the secure platform services 510 and security driver 504 of one of multiple operating systems 502. In this regard, bidirectional authentication steps performed by secure platform services API interface 508 may include the same bidirectional authentication steps previously described for secure platform services API interface 306 of FIG. 3, and each security driver 504 of a given respective guest operating system 502 may be present to perform the same task/s as previously described for security driver 304 of FIG. 3. After bi-directional authentication is successfully performed, secure communication is then allowed to take place between secure platform services 510 and a given secure services client (i.e., one of multiple operating guest systems 502a through 502n).

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, or any other suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communications between the various hardware components.

It will be understood that software and/or firmware for an information handling system and/or the methods disclosed herein may be implemented as a computer program of instructions embodied in a tangible computer readable medium, the instructions of which when executed act to perform the functions, tasks and/or steps described herein.

While the invention may be adaptable to various modifications and alternative forms, specific embodiments have been shown by way of example and described herein. However, it should be understood that the invention is not intended to be limited to the particular forms disclosed. Rather, the invention is to cover all modifications, equivalents, and alternatives falling within the spirit and scope of the invention as defined by the appended claims. Moreover, the different aspects of the disclosed systems and methods may be utilized in various combinations and/or independently. Thus the invention is not limited to only those combinations shown herein, but rather may include other combinations.

What is claimed is:

1. An information handling system, comprising:
a first processing device, at least one operating system executing on said first processing device;
a second processing device configured to perform secure platform services that include at least one cryptographic task or at least one cryptographic key management task, said second processing device being inaccessible to said operating system; and
dedicated memory coupled to said second processing device, said dedicated memory being inaccessible to said operating system;
wherein said first processing device is configured to be coupled to said second processing device by a secure communication path that comprises at least one of a secure authenticated channel, an encrypted channel, or a secure session.

2. The information handling system of claim 1, further comprising secure storage that is available to a cryptographic processor; wherein said first processing device comprises a central processing unit (CPU); and wherein said second processing device comprises said cryptographic processor.

3. The information handling system of claim 1, wherein said dedicated memory comprises embedded firmware or secure memory.

4. The information handling system of claim 1, wherein said first processing device comprises a security driver executing thereon; wherein said second processing device comprises an application programming interface (API) executing thereon that is configured to perform bidirectional authentication between said operating system and said secure platform services; and wherein said security driver communicates with said API across said secure communication path.

5. The information handling system of claim 1, wherein two or more guest operating systems are executing on said at least one first processing device; wherein a hypervisor is executing on said at least one first processing device; and wherein said first processing device is configured to communicate with said second processing device across aid secure communication path and through said hypervisor.

6. The information handling system of claim 5, wherein said first processing device comprises a respective security driver executing thereon that corresponds to each of said two or more operating systems; wherein said second processing device comprises an application programming interface (API) executing thereon that is configured to perform bidirectional authentication between said operating system and said secure platform services; and wherein each of said security drivers communicates with said API across said secure communication path.

7. A method of providing secure services for an information handling system, comprising:
providing an information handling system comprising first and second processing devices, and dedicated memory coupled to said second processing device;
providing at least one operating system executing on said first processing device; and
performing secure platform services that include at least one decryption or encryption task or at least one cryptographic key management task using said second processing device;
wherein said second processing device and said dedicated memory are inaccessible to said operating system, and
wherein said first processing device is coupled to said second processing device by a secure communication path that comprises at least one of a secure authenticated channel, an encrypted channel, or a secure session.

8. The method of claim 7, wherein said information handling system further comprises secure storage available to a cryptographic processor; wherein said first processing device comprises a central processing unit (CPU); and wherein said second processing device comprises said cryptographic processor.

9. The method of claim 7, wherein said dedicated memory comprises embedded firmware.

10. The method of claim 7, further comprising providing a security driver executing on said first processing device; and providing an application programming interface (API) executing on said second processing device that is configured to perform bidirectional authentication between said operating system and said secure platform services; wherein said security driver communicates with said API across said secure communication path.

11. The method of claim 7, further comprising providing two or more guest operating systems executing on said first processing device; providing a hypervisor executing on said first processing device; and wherein said first processing device is configured to communicate with said second processing device across said secure communication path and through said hypervisor.

12. The method of claim 11, further comprising providing a separate respective security driver executing on said first processing device that corresponds to each of said two or more operating systems; providing an application programming interface (API) executing on said second processing device that is configured to perform bidirectional authentication between said operating system and said secure platform services; and wherein each of said security drivers communicates with said API across said secure communication path.

13. An information handling system, comprising:
a first processing device, at least one operating system and a virtual machine environment executing on said first processing device, said virtual machine environment being inaccessible to said operating system; and
dedicated memory coupled to said first processing device, said dedicated memory being accessible to said virtual machine environment and being inaccessible to said operating system;
wherein said virtual machine environment is configured to perform secure platform services that include at least one decryption or encryption task or at least one cryptographic key management task; and
wherein said virtual machine environment is configured to communicate with said operating system by a secure communication path that includes a virtualization layer and that comprises at least one of a secure authenticated channel, an encrypted channel, or a secure session.

14. The information handling system of claim 13, wherein said dedicated memory comprises embedded firmware.

15. The information handling system of claim 13, wherein said first processing device comprises a security driver executing thereon; wherein said virtual machine environment comprises an application programming interface (API) executing therein that is configured to perform bidirectional authentication between said operating system and said secure platform services; and wherein said security driver communicates with said API across said secure communication path.

16. A method of providing secure services for an information handling system, comprising:
providing an information handling system comprising a first processing device;
providing at least one operating system and a virtual machine environment executing on said first processing device, said virtual machine environment being inaccessible to said operating system;
providing dedicated memory coupled to said first processing device, said dedicated memory being accessible to said virtual machine environment and being inaccessible to said operating system; and
performing secure platform services using said virtual machine environment, said secure platform services including at least one decryption or encryption task or at least one cryptographic key management task;
wherein said virtual machine environment is configured to communicate with said operating system by a secure communication path that includes a virtualization layer and that comprises at least one of a secure authenticated channel, an encrypted channel, or a secure session.

17. The method of claim 16, wherein said dedicated memory comprises embedded firmware.

18. The method of claim 16, further comprising providing a security driver executing on said first processing device; and providing an application programming interface (API) executing in said virtual machine environment, said API being configured to perform bidirectional authentication between said operating system and said secure platform services; wherein said security driver communicates with said API across said secure communication path.
